(19) United States
(12) Patent Application Publication
(10) Pub. No.: US 2016/0335674 A1
(43) Pub. Date: Nov. 17, 2016

(54) ITEM CLASSIFICATION METHOD AND SELECTION SYSTEM FOR ELECTRONIC SOLICITATION

(71) Applicant: INTEMA SOLUTIONS INC., Montreal (CA)

(72) Inventor: Sébastien PLOURDE, Longueuil (CA)

(21) Appl. No.: 15/110,307

(22) PCT Filed: Jan. 15, 2015
(86) PCT No.: PCT/CA2015/050024

§ 371 Date: Jul. 7, 2016

Related U.S. Application Data
(60) Provisional application No. 61/927,723, filed on Jan. 15, 2014.

(51) Int. Cl. G06Q 30/02; G06F 17/30; G06Q 10/10

(52) U.S. Cl. CPC G06Q 30/0269; G06Q 30/0276; G06Q 30/0277; G06Q 10/107; G06F 17/30707; G06F 17/30864

(57) ABSTRACT

The present application discloses a system to efficiently index advertisement content using artificial intelligence to infer and generate meaningful thematic category groupings for said content. Said groupings are further matched to collected customer profile data and combined to deploy custom media solicitations via 5 predictive analytics, thereby addressing the problem posed by ineffective mass solicitations which often inadequately target—and therefore miss—their intended audience.

This application claims priority of U.S. provisional patent application 61/927,723 filed Jan. 15, 2014.

### TECHNICAL FIELD

The present invention broadly relates to overlapping aspects of internet marketing, e-commerce, and data analytics. More specifically, it relates to post-click marketing and online lead generation, encompassing the disciplines of custom media, marketing management, artificial intelligence, statistics, and analytics.

### BACKGROUND

The advent of the internet, along with the power of the underlying computing platform on which it operates, has brought new possibilities for marketing products to target groups. Online marketing has evolved in tandem with the evolution of the internet itself, combining various technologies and disciplines to provide increasingly sophisticated methods by which to understand a target user or customer base with a view to presenting said group with appropriate advertising, information, or other content. The proliferation of online shopping (e-tailing) opportunities for internet users, in addition to the many novel aspects afforded by such experiences, has enabled online merchants and service providers to collect, analyze, and accordingly respond to information gleaned both from individual usage profiles and collective trends. Massive amounts of information collected on the interest generated by specific content or by a particular product may in turn be used by marketers to craft product lines better suited to target users or market segments, with a view to increasing corporate profitability, in addition to fostering beneficial competitiveness by being more responsive to their respective markets, thus permitting to achieve a balance between innovation and matching product offerings with customer demand.

As mentioned, the computational underpinnings of the internet are particularly well-suited to such tasks. These technical foundations have helped online advertisers devise marketing strategies with a granularity and precision unimaginable prior to the widespread proliferation of the internet. Indeed, much information has been collected, analyzed, and learned from. As a result, various aspects of the advertisement process have been automated and require little to no human intervention whatsoever to run optimally.

Despite this, however, certain aspects of modern email marketing strategies remain captive to a largely manual paradigm, requiring the direct involvement of human marketers and other administrative staff to assemble, manage, correct, optimize or otherwise intervene in one or more critical facets—either of advertising campaigns or their underlying marketing systems—in often fundamental ways.

One particularly unfortunate limitation inherent to existing systems concerns the categorization of new advertising content within said systems. Such categorization may involve aspects including how to categorize said ad or ads within a marketing system, and require extracting attributes about such elements as content, including one or more aspects of or within said content that would appeal to customers in a hypothetical advertisement. Typically, such items require significant human intervention, often in the form of manual contribution by a human marketing manager. The nature of such manual human involvement is often error-prone and tedious, and the system and solicitations that result are limited and often impaired in their flexibility and scope.

The needs of product or content creators, marketers, and customers should and must be better served by the paradigms available to them, failing which these paradigms should be modified or discarded altogether. A system that can spare the creator of content (or the marketer of a product) the need to ascribe—often subjectively—categories or attributes to said product or content, or to likewise spare him the tedious and error-prone tasks of determining in advance which individual profiles (often of questionable completeness and therefore reliability) out of a large bank of customers may be interested in receiving specific content or solicitations for said content or product, could surely improve the situation. A solution that can avoid needless and/or poorly targeted solicitation can save time, money, resources, and avoid recipient frustration. Similarly, targeted solicitation whereby one or more potential buyers and sellers are joined based on a known set of said individual buyers' needs or interests and individual sellers' offerings could also provide much-needed relief. An improvement on one or all of these fronts may be arrived at by way of a more optimal automation, and integration. Such automation may be achieved using linguistic analysis of the content within product descriptions themselves, combined with an automated matching and delivery system better suited to one or more target audiences.

Such is an object of the invention described herewith.

### SUMMARY

In an effort to spare marketing managers and content promoters the onerous challenges of manually and sometimes subjectively identifying the individual aspects of their articles—whether products, content, or services—that may appeal to their most appropriate clienteles, the present invention, with the modules and functionality as configured and summarized herein, may be envisioned.

Such a configuration typically consists of five key components (FIG. 1):
1. An Advertisement content database (M01) receives and stores the product descriptions, articles, or fundamental content that forms the basis of the marketing campaign to be distributed to customers, also called clients, or users.
2. A Text Analysis module (M03) receives product descriptions from the content database (M01) and performs a linguistic analysis of said descriptions. The purpose of such analysis is to extract keywords as well as to infer and generate category groupings for said content, both of which will form important bases for future marketing campaigns. The result of the analysis is a generated set of weightings for various retained product attributes, to be used in subsequent steps.
3. A Client attributes module (M13), which essentially stores the recipient profiles, including statistical information in the form of numerical scoring data and category data for each category generated in the text analysis (M03) module, and is maintained and updated through a post-click history keeping mechanism collected ideally over the course of multiple marketing campaigns, said history allowing to develop an accurate and continuously refined profile for each member within a set of customers as a result. Said profile is to be used in predicting or otherwise anticipating which among a set of articles to optimally solicit to a set of customers using the components enumerated subsequently and further described in the present disclosure, and based on the constructed behavioral profile of each said customer.
4. A Pairing module (M09A), receives attributes about products from the content database (M01) as well as the above-mentioned product attribute weightings from the Text Analysis module (M03). It also receives one or more sets of Client attribute data (M13), which is a cornerstone to determine whether one or more products having a given set of attributes may be appropriately and predictively matched with a given set of one or more target audience members. Largely replacing the various aspects of assessing the appropriateness of products for target customers previously performed by humans, particularly on a static and per-campaign basis, the Pairing module (M09A) carries out this step by dynamically comparing assigned product attribute weights with known client attributes (and interests profile), the latter of which have been collected through repeated use of the system by said customers. Said attribute data may be variously aggregated, whether through the direct intervention of a human campaign administrator using an embodiment of the present invention, or dynamically through the machine learning capabilities with which an embodiment the invention has been configured. Furthermore, said aggregation of data may follow various combinatorial configurations. For example, profile attribute aggregation may variously result from the combination of multiple attributes, including behavioral characteristics, collected from a single client. Alternatively, such aggregation may take the form of a single profile attribute collected among multiple customers. More frequently, a specified blend of the foregoing combinatorial arrangements is applied. Such arrangements, and particularly the information extracted from them, form the basis of the predictive analysis aspect encapsulated by embodiments of the present invention. The implementation of said predictive analysis aspect is not the scope of this or any other single module described herein but rather the cascaded effect of multiple modules.
5. The relative placement of content within a publication, whether an email message, newsletter, smart flyer, or some other specified format—including but not limited to one of several possible standard template layouts—wherein associated selection criteria to populate and arrange items within said publication or layout are issued to the product selection-to-template layout concordance module (M09B). A key element within this module is the presence of a computer algorithm to predictively select via ranking and matching (M09B1) the affinities linking individual clients with one or more items contained within the content database (M01). The result of the aforementioned matching process (M09B1) or concordance is the generation (M09B2) of a populated template based upon said ranking and matching operation, which may be variously packaged and transmitted, via any of several channels, including via email or through a user's individual portal account. Accordingly, the prediction-based concordance allows for the generation of customized media, wherein the specific presence, placement, and layout of items within said publication based on specified predictive analytics criteria enable the resulting publication to yield superior marketing performance compared with more naïve bulk solicitations, as a result of said publication's attempt to individually anticipate the needs and/or areas of interest of each customer or recipient to whom it is transmitted.

The present application discloses a system to efficiently index advertisement content using artificial intelligence to infer and generate meaningful thematic category groupings for said content. Said groupings are further matched to collected customer profile data and combined to deploy custom media solicitations via predictive analytics, thereby addressing the problem posed by ineffective mass solicitations which often inadequately target—and therefore miss—their intended audience.

While a significant emphasis is placed in the present disclosure on the marketing and solicitation of consumer articles—whether products, goods, and services—it will be appreciated that the content database (M01) need not be limited to such merchandise but may include any other sort of information, non-limiting examples of which include content such as news articles, movies, cooking recipes, and images, with the necessary modifications made to the various modules described herein.

### BRIEF DESCRIPTION OF THE DRAWINGS

The invention will be better understood by way of the following detailed description of embodiments of the invention with reference to the appended drawings, in which:

FIG. 1 is a block diagram depicting the key modules required to carry out a marketing campaign using an embodiment of the present invention.

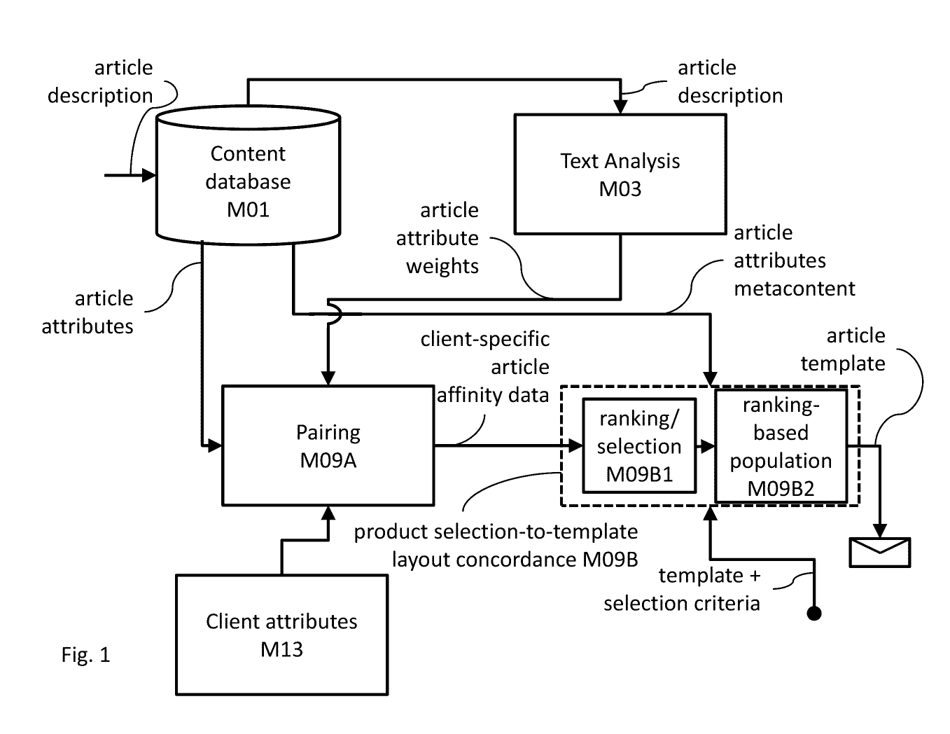

FIG. 2 is a block diagram depicting the key modules of an embodiment of the present invention with a particular emphasis on the data paths and inter-module relationships underlying said embodiment's post-click data tracking functionalities for the purposes of accumulating predictive analytics.

### DETAILED DESCRIPTION

In the following description, the use of “he” or “she” is not intended to refer specifically to gender, but rather simply to a user of either gender.

With the arrival of each new technology comes a new means by which to chronicle aspects of the world perceived within a given time and place, or alternatively to convey visions or imagined ideals of that world. At the same time, and in virtually all societies, advancements in technology, commerce, and communication have spurred development, and more broadly, human evolution itself. The progression from primitive scrawls, cave paintings, and artifacts recovered from archeological sites, to architecture both ancient and modern, to extant mosaics, religious imagery, and indeed to text and literature bear witness to this evolution. And through this evolution push and pull factors—whether technologies, commercial impetuses, or modes of communication—have at times been unwittingly combined and other times deliberately fused. New messages, and occasionally, new forms themselves have resulted from such combinations and mergers.

The forces of combination and reuse are plainly visible in the historical progression of communication mediums, one that includes cave paintings, etchings, sculptures, renaissance art, the printing press, radio, and television. By way of synthesis, it will be appreciated how all these forms have recently entered the digital age and had their underlying representation articulated—often retroactively—and in turn unwittingly combined or deliberately fused—using binary logic. It is noteworthy that the medium of communication through which a message is sent has been observed by scholars to both affect and shape the way in which humans relate to and are affected by it.

It is perhaps unsurprising, then, that with the arrival of each new technology have come means by which to communicate about commerce, or more plainly, to advertise. The fundamental purpose of marketing—and indeed of a market itself—is to foster transactions matching a buyer and a seller. The individual variants by which this goal has been sought and achieved have of course varied by time and place, but the underlying principle of linking supply and demand has essentially remained unchanged since prehistoric times. The actual form of markets have evolved, with designated market days and sections often giving way to centralized malls and stores.

More broadly, the era of mass marketing brought with it increasingly selective and somewhat demanding consumer bases, ushering in stiffer competition between frequently competing suppliers over what the latter understood, despite global ambitions (whether tacit or declared), was an often finite set of potential customers.

Beyond its initial meaning confined to location, the very word “market” itself took on an additional nuance, namely the pool of targeted individuals themselves. Rather than disseminate their message indiscriminately, the importance of courting (potential and existing) customers—through better engagement within their own markets—became apparent to suppliers. This led to new ideas and practices aimed at optimizing various aspects of solicitation.

The process begun with widely-circulated print media spilled into radio, and television soon afterward. Combined, this trio constituted a near-monopoly of the “modern” advertisement channels available to twentieth-century mass marketing professionals. Advertisement acquired a creative dimension, often blending some market studies with non-empirical perceptions. The trend toward more in-depth market studies accelerated, as did the application of more sophisticated persuasive means.

The internet has brought new opportunities for marketers. Like the many communication mediums that came before it, a sophistication process whereby the ways to use (and misuse) the technology are continually being explored. One such misuse of internet technology for the purposes of advertisement has been the proliferation of spam. Indeed, anti-spam technology, together with more scrupulous marketers' attempts to more intelligently target their messages to more appropriate recipients has followed. However, the attempts—as well as the corresponding results—have been far from perfect, as they still require human intervention in whole or in part to vet significant aspects either of the advertisement content itself or the set of users to target (and frequently both of these).

Human vetting of such fundamental aspects of a marketing campaign is deplorable for several reasons. First, it is antithetical to the nature of the internet itself, namely a highly advanced communication medium whose structure and components are based on computation, and logic, and one that is capable of processing large amounts of data at rates never before seen. Second, such human intervention, and the decisions resulting from it, are, in a manner reminiscent of their twentieth-century counterparts, not guaranteed to be based upon empirical data, and may thus be error-prone, potentially undermining the success of the campaign itself. Thus, even in some of the most advanced marketing systems, a large degree of subjective human involvement in matching buyer and seller risks yielding results that in many respects are only marginally better than those of their forbears.

The effects of poor marketing, and in particular poorly targeted advertising—soliciting recipients who have no need for a product or service—are fairly well understood. From this perspective, using the internet to indiscriminately if not carelessly disseminate content to poorly chosen recipients represents not only a gross and fundamental misappropriation of this new and powerful technology and a misunderstanding of its promise, but applying anachronistic marketing strategies using this medium, whether in whole or in part, often represents unnecessary effort on the part of the marketer (including but not limited to that which can be measured in terms of time and money), and promotes egregious and thoughtless consumption of network bandwidth, energy, and time on all internet users. This situation is sadly all too pervasive and at best produces disparate results. And it is unacceptable.

The various embodiments of the online marketing system disclosed herein propose a means by which to significantly reduce the inefficiencies, tedium, and waste in resources resulting from the use of contemporary online marketing systems. This is accomplished by reimagining the campaign conception process in a manner that reduces human involvement, both in the critical step of pairing content with potential recipients, as well as by inferring intelligent categorization techniques by which to index and retrieve said content. Such improvements, both in the conception and the subsequent deployment of campaigns, play instrumental roles in effective marketing in general and in efficient delivery of said campaigns in particular.

The data source upon which a large number of embodiments of the present invention rely is a pool of content, the essence of which is rationally connected with the specific purpose for which the system is intended to be used, in addition to the overall objective of improving marketing effectiveness. In many of the embodiments described herein, the foregoing content pool is specifically designated as an Advertisement content database (M01), namely for the capacity in which it serves as a repository for all advertisement content provided or otherwise available to the system. In such embodiments, the precise meaning of the term “advertisement content” is to be appreciated as a deliberately flexible notion. In an embodiment, such content may be introduced and stored within the database (M01) as discrete elements. In another embodiment, such content may describe or be otherwise aggregated and inextricably associated with particular products. Furthermore, the notion of “product”, as discussed throughout, should, in a manner analogous to that of “advertisement content”, be appreciated as having an equally broad meaning and non-restrictive scope. In this way, both the type and nature of things to be traded, marketed, and/or transacted by way of an embodiment of the present invention—namely by means of solicitation further discussed herein—and contained within the database (M01), may comprehensively encompass diverse forms. A non-limiting enumeration of the object(s) of such potential transactions includes physical and tangible products and/or goods, in addition to more abstract, intangible, and/or less corporeally commoditized ones, such as the consumption of a news article, the viewing of a video, the offer and procurement of a service, as well as any permutation of the foregoing.

Examples of the product descriptions introduced to the Advertisement content database (M01) include, without limitation, elements such as textual information, image data, audio, and video recordings. All of the foregoing may be stored in raw or native format, or using any popular, proprietary, or otherwise specified data format for said element. The information represented by content introduced to the database (M01), by an administrator or other human operator upon whom such privileges have been conferred, may include, without limitation, product description data sheets containing information describing the product with varying granularity. In some embodiments, the granularity of such information may provide, without limitation, one or more known names of a product or means by which to refer to it, in addition to other identifying information. In various embodiments, such information may identify, without limitation, said product's provenance, price, manufacturer, designer, creator, supplier, resellers, dimensions, appearance, taste, and other attributes considered proper for, appropriate, and relevant to the type of product being described, as well as variants for each of the foregoing elements. As a function of the embodiment, such description may accessorily or compulsorily contain photographic or video representations of products, as well as variants if available or deemed appropriate. Furthermore, content representing a product or any constituent product description element within the database (M01) may be in one or several languages. With the appropriate modifications, comparable information may be provided when the object of a solicitation is a service.

In addition to various embodiments of the present invention imposing no limitation on the type and number of underlying data formats that may be used to store the various product description element types enumerated non-exhaustively herein, a similar freedom characterizes the manner in which discrete said types of product description elements are organized, encapsulated, or otherwise mutually interconnected by one or more human operators within said database (M01) itself. Alternatively, any number of otherwise disparate records existing within said database (M01) may, in another embodiment, be aggregated or amalgamated by one or more human operators. Such aggregation is a largely fluid notion whose primary purpose is to make it possible to externally, explicitly, and conceptually group various items within the database (M01). The purpose of such grouping is to facilitate or otherwise influence the operation the operation Text Analysis module (M02), further described herein, in its task of cybernetically extracting meaningful and contextually relevant product categorizations. To cite a non-limiting example of such human-specified aggregation, assembly instructions for an item of furniture might be explicitly associated with images of said item and video instructing viewers on its assembly. As a corollary, a human operator may wish to disassociate a previously aggregated set of items; this might be desirable, for example, when a product is recalled or a variant is discontinued and it is no longer feasible or even possible to continue a previously-valid aggregation.

As discussed above, a broad interpretation of the types of content that may be stored within the database (M01) is appropriate, as the nature of an embodiment of the present invention need not be artificially restricted by or otherwise bound to a singular family of content. Accordingly, it will be appreciated that a broader appreciation of what constitutes content within embodiments of the present invention allows said embodiments to be deployed within diverse environments with relative ease. Thus, in addition to or in lieu of the above-mentioned elements described above, a “product” need not be imagined as a tangible good, but in some embodiments may also be a service or alternatively some form of intellectual property, such as a written article or video whose purpose need not even be advertising-related.

Furthermore, while the present disclosure largely refers to a content database (M01) using the grammatical singular, it will be appreciated that such usage is intended to encapsulate merely a singular conceptual entity and not necessarily a sole material one. Thus, it should not be inferred that references to said content database (M01) be uniquely limited to—or construed as being limited to—a single database alone. As a conceptual entity, the content database (M01) may, in embodiments of the present invention, accordingly encompass one or more databases configured and disposed within one or more computers, interconnected by way of any network topology, operating using any communication protocol, and possessing any organizational scope.

Likewise, the content set stored within the database (M01) need not be static, but rather may change with time. Accordingly, the addition, modification, and removal of content within said database (M01) may, in various embodiments of the present invention be subject to an accessibility policy restricted to one or many human users, who may optionally be assigned one or more access profile types whose privileges variously limit or confer specific view and/or editing capabilities. As a non-limiting example of profile assignment, user types authorized to access the database (M01) might be apportioned among one or more content creators, whose work is vetted and controlled by one or more content editors, whose access accounts are created by one or more senior administrators.

In another embodiment, content submitted to the database (M01) may be manually edited or removed, or, in a further embodiment, subject to an expiry date, following which said content it is automatically deleted and expunged from the database (M01). The parameters whereby such deletion policies can be specified may be made available to human operators possessing senior administrator privileges and deletion policies may be further tailored, as a non-limiting example, to specific user accounts or content types.

Text Analysis Module

Items stored within the content database (M01) are accessed by the Text Analysis module (M03), responsible for receiving product descriptions from the content database (M01). Accordingly, the Text Analysis module (M03) receives product descriptions stored within the content database (M01) and by way of one or more analytics techniques generates weighted product attribute values extracted from said product descriptions. Said product attribute weights serve to determine whether—or alternatively, the extent to which—one or more products within the content database (M01), may, as a result of their respective product attribute sets, be appropriately paired with client attributes (M13), the latter of which accordingly represent both known and statistically inferred interests of a specified set of customers' client attributes, the latter of which are at least in part collected by way of predictive analytics processes. The operation of the latter module (M13) is subsequently discussed in the present disclosure; discussion of the operation of the Text Analysis module (M03) will be undertaken at present.

The work of the Text Analysis (M03) module is in large part a natural language processing data mining and analytics operation, compounded with the task of performing said analysis on one or more sets of content which in many cases is textual but which in some embodiments of the present invention need not be limited to such. The database (M01) stores content whose organization—particularly among various content items for the same product—may be variously strong or weak. Weighted product attribute values generated by the Text Analysis (M03) module represent numerical statistical influence assigned to each of the descriptions in the database (M01) that have been made available to the text analysis module (M03) for purposes of extracting keywords, and more specifically, inferring and generating meaningful thematic category groupings from said content (M01). A key improvement offered by the present invention over preceding online marketing systems is the comprehensive use of artificial intelligence to accurately and contextually carry out two important tasks. The first of these tasks is the extraction of information sufficient to derive one or more category descriptors from the supplied product descriptions, while the second is to attribute numerical statistical weight to said category descriptors. An iterative process by which numerical statistical weightings are attributed to previously extracted category descriptors, including for those derived for descriptions associated with other products, is also necessary to supply the remaining modules of the system, described in detail subsequently, with the most appropriate product attribute weight data. The Text Analysis module (M03) does this using artificial intelligence, semantic analysis, and text mining processes appropriately robust and suited to the deployment a specific embodiment of the present invention. Regularity in repeating this process, either in whole or in part, is also necessary to ensure the freshness of the resulting data; accordingly, it will be appreciated to a person having ordinary skill in the art that in many embodiments, database atomicity properties need be fully considered.

A machine learning algorithm adequately adapted to the types and formats of content stored within the content database (M01) is deployed within the Text Analysis (M03) module to categorize said content. A preliminary yet vital aspect to consider is said algorithm's ability to properly interpret the various content (M01) to which it will be applied. In various embodiments of the present invention, the content may be rendered into in a form adequate for analysis by said algorithm. Adequacy in these contexts entails the algorithm's ability to properly interpret both the various structures and formats of the content made available to the Text Analysis module (M03) in order to accordingly generate meaningful thematic category groupings, further described herein.

A thorough information extraction analysis is performed on the product descriptions provided to the Text Analysis (M03) module. The explicit type of analysis to be done is largely dependent on the potentially variable types of product descriptions provided, and thus in many embodiments of the present invention, it is preferable to implement and deploy corresponding components involved in the analysis modularly. Such modules provide natural language processing (NLP) and image processing capabilities vital for interpreting supplied product descriptions with a view to appropriately infer categorization terminology. In various embodiments, multiple sub-modules, each of which is devoted to a specific task, interoperate to successfully generate said categorizations for a given set of product descriptions. In this endeavor, the module must typically be outfitted with various NLP capabilities, a non-limiting enumeration of which includes automatic summarization, discourse analysis, machine translation, morphological segmentation, relationship extraction, and sentiment analysis.

In some embodiments of the present invention, a relatively straightforward filtering and removal of inconsequential words is typically carried out. Next, a language-specific stemming algorithm is applied, wherein related words are intelligently reduced to a common word stem (e.g. “phone”, “phoned”, “phoning”, and “phones” all become “phon” where appropriate). Weighting is conducted on the result of words so stemmed, after which a comparison of the frequency and repetition of words or other literal strings is made. Words or other such strings are subsequently sorted and scored for their particular relevance in the context of said article or description.

In various embodiments of the invention, each of these functionalities may be further implemented and deployed as separate interconnected modules or alternatively integrated within a single module capable of learning and generating categorizations of the types further described herein. Related activities may additionally be required and accordingly deployed within the Text Analysis (M03) module should the product descriptions provided be of a specifically non-textual nature (e.g. images, audio or video), with the necessary modifications to the foregoing text mining and NLP functionalities mentioned previously. Such related activities may include optical character recognition, image analysis, speech segmentation, speech recognition, and other related non-textual information extraction steps to properly extract categorization information from supplied aural and/or graphical product description content and assign a statistical value to each category so extracted from any and all of the various media types that constitute the product description sources.

An important aspect in accomplishing the categorization and generation of meaningful thematic groupings discussed above is the ability to continually adapt a set of related analytics duties to a potentially evolving set of product descriptions. While numerous embodiments of the present invention call upon multiple forms of artificial intelligence rather than direct human intervention to generate categorization headings and weightings, leaving such generation entirely up to even the most advanced contemporary machine learning module(s) alone carries the risk of unforeseen, unintended, and—most critically—undesired situations arising in both the Text Analysis module's (M03) generation of categorization headings as well as the assignment of weighted attributes to the latter. Applying one or more supervised learning approaches to numerous embodiments of the present invention in an effort to mitigate the risk of such undesired situations (as well as the consequences that would result) constitutes both a necessary and desirable safeguard. A key consideration for applying a supervised or even a semi-supervised learning approach to the module (M03), rather than an entirely unsupervised one in particular, lies in the former approaches' permitting important safeguards, which in turn allow senior and/or administrative users of an embodiment of the invention to maintain and ensure operational quality control of embodiments of the present invention. In some embodiments, one or more aspects pertaining to one or more modules or submodules discussed herein may be subject to the principles of and/or be implemented via one or more known varieties of in-database processing. Such in-database processing may be particularly desirable in light of the iterative and frequent processing of content, especially when content is frequently added, removed, edited, or an aggregation of various content elements is explicitly established by a human operator.

In an embodiment of the present invention, the product attribute weights generated by the Text Analysis module (M03) may be in any form and format intelligible to the Pairing (M09A) module, further described herein. As a non-limiting example, these may be expressed, on the one hand, by way of a simple attribute-value system, or on the other be represented using one or more variously complex transfer matrices. The meaningful thematic category groupings inferred and extracted by the present module (M03) may be stored within one centrally located database, or split among multiple specially-designated sites. Said category groupings may be further generated, extracted, and/or stored, in a non-limiting enumeration, according to the foregoing's translations, synonyms, equivalents, or other abstractions. Said category groupings may also typically be words in one or several languages, although in some embodiments, they may likewise be an alphanumeric string representing any natural human language or some other representation using any other system by which information may be encoded and/or decoded. It will be appreciated that given the various functionalities described herein flowing from the various logical problems it must solve, including, without limitation, classification, novelty detection, knowledge discovery, and data processing, the Text Analysis module (M03) may be implemented by way of an artificial neural network.

Client Attributes

For several embodiments of the present invention, the presence of one or more customer intelligence sources is a critical necessary counterpart of the Text Analysis (M03) module described herein. The client attributes (M13) module may be seen as a construct that amalgamates such customer intelligence and makes it available to the system described herein, further to the latter's stated purpose.

Client attributes are important aspects of the system in that they provide key customer intelligence data necessary to build effective marketing campaigns. Such campaigns ideally and optimally combine advertisement content with known customer interests. For the purposes of embodiments of the present invention, collective trends may be gathered and constitute useful information for campaign management in an aggregated form; however, in its most valuable form, such customer intelligence provides insight on the personalized experience and behavior of individual users.

Managers and other individuals designated with specific sets of operator privileges consistent with assigned task structures, trust level, and campaign assignments to name a few non-limiting criteria, may be provided access to specific portions of an embodiment of the present invention's back end, including but not limited to specific undisclosed administrative or operator web portal URLs or through a secured connection to the main computer system upon which an embodiment of the present invention is deployed. Allowing such access to designated human operators accomplishes two vital objectives; first, it allows advertisement campaigns to be created and managed, and second, it ensures that any and all modules of an embodiment of the present invention to which they are granted access are operating correctly.

Front-end access to embodiments of the present invention may follow a similar paradigm; however, it will be appreciated that certain logistical and functional differences exist. A first consideration concerns the method by which embodiments of the present invention may gain or otherwise acquire users or customers to solicit via targeted advertisement campaigns. Such acquisition and subsequent interaction may occur via multiple means in various embodiments of the invention. In some embodiments, individual customers may create their own accounts within said embodiment using a web interface similar to user account creation interfaces seen on various web sites, enabling said customers to subsequently connect to the system; one non-exhaustive means to achieve this may include logging into a dedicated user session by way of a secure web browser connection. Indeed, such sessions might be established with a direct and explicit visit to a centralized web site and/or server where an embodiment of the present invention is hosted, with all interaction occurring within said web site following user authentication, which in some embodiments may be completed, as a non-limiting example, with the entry of a username and corresponding password combination. In other embodiments, interaction with the system may be far less centralized, employing technologies such as persistent third-party web cookies or other session-specific tracking technology deployed on multiple external web sites to both target account-holding customers and relay said customers' behavior to an embodiment of the present invention. The latter scenario, while offering a more unconstrained experience to a user affords an opportunity for him to receive targeted solicitations while navigating internet pages in the course of his typical web browsing patterns. Such external web sites may be either loosely or closely affiliated with but not necessarily administered by the same party as that which administers any one or several embodiments of the present invention. In some embodiments, the advertisements displayed to persistently authenticated users may be broad in scope or alternatively be constrained by some thematic criteria; for instance, a camping website might elect to present advertisement content related exclusively to camping gear or alternatively forgo any thematic limitation on advertisement whatsoever. In other embodiments, the option to constrain external content may be provided to and decided by the user-customer instead and not a third-party web site operator.

In some embodiments, once a customer correctly completes said embodiments' logoff procedure, tracking and the related collection of data may cease. In another embodiment, advertisement campaigns might be deployed to individual recipients by way of an email message into which the explicit and/or targeted advertisement content is contained, embedded, or otherwise rendered accessible to a user, either in whole or in part, by actively accessing said content linked from said email message.

Click tracking constitutes the principal method by which an individual customer's preferences may be collected and tracked and his corresponding interest profile built. In some embodiments, such as when embodiments of the present invention are used on computing platforms such as mobile devices in which a literal mouse click is not the means by which elements within a graphical interface are selected, the appropriate modifications (such as tapping a touchscreen or uttering a voice command, for example) should be inferred.

While collecting information associating the occurrence of a user click for one or more advertisements viewed by said user, several embodiments of the present invention may also complement and correlate a user's interest profile with less explicit and more passive session data. As a non-limiting example, such information as the amount of time spent looking at a particular advertisement, the number of times the same advertisement has been accessed, whether products belonging to similar product families or categories (and if so, which ones) have been viewed, the platform on which the initial and subsequent session logins occurred, the date, time, and location information when available may additionally be collected and added to the attributes data (M13) collected for the purposes of deducing and inferring customer interest. In some embodiments, a machine learning algorithm with at least some features analogous to those discussed within the Text Analysis module (M03) may be deployed to facilitate certain inferences specifically related to client attribute data. In yet further embodiments, additional information collected may include payment patterns and language preferences, and combine collected customer intelligence data with whatever information was asked of and supplied by the customer when setting up his account, such as his name, and other demographic information such as gender and age.

In most embodiments, the collection of customer intelligence is made with a view to generate weighted statistical data in a manner and process both complementary and in some regards analogous to that generated by the Text Analysis (M03) module. Correspondingly, statistical data representing, for a set of customers, a weighted and quantified ranking of each of said customers' affinity to various meaningful thematic category groupings extracted by the Text Analysis (M03) module, is collected and calculated on an ongoing basis. Said statistical data calculations are inferred from collected behavioral evidence sources, a non-limiting enumeration of which is provided herein as non-exhaustive examples. In some embodiments, a relative weighting, preference, or bias may be assigned to one or more of said behavioral sources; such preference biases may be a result of heuristic, objective, or mere editorial consideration, or for any reason deemed appropriate by a system administrator. Further, the frame of reference with regard to which a customer's statistical data is calculated—and in some embodiments, retained and stored—may, in various embodiments be based around the data profile of the customer himself, or alternatively normalized with respect to a set or all of the clients whose attributes (M13) are determined. The weighted statistical data produced by both the Text Analysis (M03) and Client attributes (M13) modules will subsequently be paired (M09A) in a process that seeks to accurately solicit a customer with one or more product advertisements using knowledge of what products and product categories are likely to be appealing to said customers. While the explicit interface and presentation might differ according to the embodiment(s) under consideration, the overall procedure remains essentially comparable, iterating for one, some, or all customers at a time, said customer(s) having affiliated with an embodiment of the present invention. The decision of whether to select target recipients as a function of advertisement content or vice versa may be implemented as complementary features of various embodiments of the present invention, with either or both features made available as a point of situation-specific consideration for administrative staff responsible for planning and deploying a given marketing campaign.

Finally, in a manner analogous to that discussed for the Text Analysis (M03) module, the Client attributes (M13) information gathered and described herein may be collected, stored, and represented by any of several means, with some embodiments maintaining, by way of non-limiting example, an attribute-value table, and others representing more comprehensive client attribute data using, for example, more complex transformation matrices. Additional discussion on the role of descriptive analytics aspects instrumental to embodiments of the present invention is further provided in the present disclosure.

Pairing Module

The Pairing module (M09A) receives product attributes from the database (M01) and product attribute weights from the Text Analysis module (M03). Furthermore, the Pairing module (M09A) is configured to match the foregoing product-related attributes with individual client attributes (M13). The extent to which product-related attributes are matched with Client attributes (M13), including considerations pertaining to operational extraction and integration frequency of the respective corpora, in addition to the scope of the respective corpora to be integrated, as well as any additional aspects described herein, are administrative considerations that may be contemplated alternatively on a per-embodiment basis or as aspects permitted or features available within classes of distinct embodiments. Nonetheless, the foregoing product-related attributes are matched in such manner as to produce weighted set of client-specific product affinity data, further described herein.

A significant aspect governing the usage of the pairing module relates to determining which of the two main attribute types (i.e. client-related or product-related) will be operated upon, and which will serve as the predicate. Specifically, it is necessary to first determine whether the purpose of a given advertisement campaign is to match a set of products with customers known or likely to be most receptive to said products, or conversely, to match a given set of customers with products known or likely to be most appealing to said customers. While a significant proportion of the embodiments discussed herein assume the latter scenario, it will be appreciated that in many practical situations, the former scenario may prevail as well. In such cases, a reading of the present disclosure, bearing in mind the necessary modifications, should be made. The nature of the inferential and/or descriptive statistical approaches participating in the inference and generation of meaningful thematic category groupings underlying various embodiments of the present invention remains similar.

A key aspect of the pairing module step is the integration of the attributes independently generated by the Text Analysis (M03) and Client attributes (M13) modules. It will be appreciated that in various embodiments of the present invention, the various constituent components, including the foregoing modules, may be implemented and deployed on more than one computer, and/or at more than one physical site. Concurrent with but distinct from these considerations, several other aspects related to variations in the scalability and interconnectedness of the technologies underlying the modules described herein should be borne in mind.

One of these considerations is that a large amount of data typically requires processing in a typical embodiment and deployment of the present invention. Particularly in light of the scale of processing dictated by Big Data resources and assets—already considerable and one expected to continue its exponential growth—it is imperative, particularly in larger-scale embodiments of the present invention, that the amount of time required to carry out said processing not constrain the operation, in particular, of the Pairing module (M09A) nor its tributary modules, particularly the Text Analysis (M03) and Client attributes (M13) modules. Consequently, many of the technologies solicited to solve the various challenges introduced by Big Data may be contemplated and deployed, in a scale- and embodiment-appropriate manner, to effectively manipulate and efficiently process the large quantities of data relating to various embodiments of the present invention.

In this regard, advanced parallel processing technologies stand out as necessary elements in the two statistical corpora—one client-related and the other product-related—to be matched. To carry out such matching, the Pairing module (M09A) determines, for each customer within a given set, a statistically quantified affinity for a corresponding set of products whose content exists in the database. In some embodiments, architecture patterns including but not limited to extraction-transformation-load (ETL) may be implemented within the Pairing module (M09A) to facilitate this process. In addition to the foregoing, data mediation principles and particularly ontologically-based forms of data integration may be variously incorporated into embodiments of the present invention toward this goal.

The result of the foregoing pairing process is the production of a set of client-specific product affinity data associated to a previously-specified set of customers to target during a particular campaign. Said data is a quantified predictive measure of the extent to which each customer within said client set has been computed—given previously available behavioral history—to possess a particular interest in a given set of products retained from the content database (M01) for the purpose of a particular campaign. In some embodiments, the maximum number of products to retain for the purposes of a given campaign may be specified by a system or campaign administrator; in others, the set may incorporate all available content (M01). Furthermore, the set of client-specific product affinity data produced by the Pairing module (M09A) may be expressed using any scheme and format deemed appropriate for given embodiments of the present invention; to cite two non-limiting examples, these may range from a simple comma-separated value list, to collections of large matrices with billions of entries. Once such data has been reckoned for the desired client set, it is provided to the Product selection-to-template layout concordance module (M09B).

Concordance Module

The concordance module (M09B) is the final major component of the invention; its principal operations include ranking and selecting (M09B1) the content or articles to solicit to customers, and populating (M09B2) a specified advertisement template with content (including but not limited to advertisements) personalized for a given customer. The successful completion of both aforementioned steps results variously from aspects of the original content or from the processing and integration steps discussed previously. In their quality as a direct and especially as an online marketing solution, embodiments of the present invention are particularly influenced by challenges and trends encountered in the field of variable data printing. A key aspect in this endeavor is the cooperation between validating and then ranking the relevance of customized content to be presented on the one hand (M09B1), and ensuring that said content populates and is successfully displayed within an often fairly rigid, pre-specified page layout or template on the other (M09B2). The two sub-modules contained within the concordance (M09B) module cooperate to realize the operation of this paradigm.

It will be appreciated that although the content database (M01) may hold many types of content, each potentially under various formats, only a subset of such content typically appears within a single advertisement template customized for a given client. This is particularly relevant, considering that various instances of associated content may exist within the database (M01) for a given group of closely-related products—or for nearly identical ones. For the purposes of disclosing embodiments of the present invention, the relevant information about a product to show within the allotted space in the template and visible to the end customer are known as product attributes metacontent. In addition to receiving one or more sets of client-specific product affinity data, described previously, the concordance module (M09B) also receives product attributes metacontent from the content database (M01) directly.

As a non-limiting example, suppose that an advertisement campaign for a consumer electronics megastore were to be coordinated using an embodiment of the present invention. The Pairing (M09A) module might determine that a particular customer's client attributes (M13) suggest a considerably elevated interest level in specific varieties of mobile telephones. Suppose further that the client attributes available were sufficiently granular as to allow the predictive identification of one very specific mobile telephone model to solicit to said customer. In such cases, client-specific product affinity data regarding not merely mobile telephones but particular models thereof might be transmitted to the concordance module's (M09B) ranking/selection sub-module (M09B1). In an embodiment of the invention, the one mobile device model is predictively selected (i.e. the model having the highest statistically-quantified fitness ranking for said customer as a result of existing data of client attributes (M13) for said customer) to appear within the template layout to be accordingly populated (M09B2), generated, and sent to the targeted customer. As part of the layout duties of the module (M09B2), the one product determined appropriate to solicit to the user is retained for display within a given advertisement template layout, discussed in greater detail herein. Thus, for a particular handset model, the content to be gathered from the database (M01) and provided to the concordance module (M09B) may include the device's name, model information, a subset of its features (typically limited to salient ones), the unit's sale price, and an image bearing its likeness. On the other hand, even if it were present in the back-end database (M01), content such as the serial number used by a third party manufacturer to refer to an obscure electronic component within the handset, or perhaps the handset's date of assembly would, for evident pragmatic and contextual reasons, not likely appear within the front-end populated custom template; likewise, the device's user manual, even if available (M01) would not be ordinarily reproduced and displayed to the customer in this scenario.

In a variant example, the client attributes (M13) collected for a given customer may suggest that not one, but rather a plurality of mobile devices (having comparable or possibly different characteristics) whose descriptions are contained within the database (M01), might be predicted to be of interest to the customer. In this case, the mobile device models to be retained are selected (M09B1) as a function of their respective predictive ranking, and provided to the ranking-based population sub-module (M09B2). The latter sub-module (M09B2) accordingly populates the template with the subset of mobile phone models both as a function of the respective ranking attributed to each handset model and the template selected and any externally-specified selection criteria (e.g. populate the template with a maximum of 2 mobile handset devices, placing the highest-ranked device first in the populated template), to be further discussed presently.

An additional and equally important aspect of the concordance module (M09B) concerns the content management functions by which it enables administrative users of an embodiment of the invention to select from among of one or more generic advertisement templates and their associated graphical layout. Although such content management functionality typically includes aesthetic and design-related considerations, it also allows an administrator to make fundamental editorial decisions on content, including critical judgments of whether and how to prioritize, categorize, and coordinate various aspects of individual advertisement campaigns to conduct. Such functionalities include, by way of non-limiting example, the ability for one or more administrators to set, meet, or optimize specific objectives of an artistic or economic nature, such as by interchanging the relative positions of retained items from their original and automatic positioning conferred by the module (M09B) for one or more customers, as well as the ability for one or more administrators to manually override the determinations made by the Pairing (M09A) and concordance (M09B) modules by removing and optionally replacing one or more of the products appearing and laid out in an automatically-populated template with one or more other items in the database (M01). In various embodiments of the present invention, it is possible to have a library of not one but several templates or pre-developed page layouts, each offering various possibilities to variously lay out and customize the appearance of content. Such customization may include, without limitation, font selection schemes, text size, image size, color schemes, corporate branding, and seasonal publication. Such decisions may be specified externally and supplied to the concordance module (M09B), or alternatively be implemented as an additional interface component or submodule within the concordance module (M09B) itself.

The output of the concordance module (M09B) is the customer-specific populated template resulting from the combined operations of all previously described modules, which in many embodiments is customized and deployed in accordance with the known communication preferences of a given customer in addition to other potential administrative or editorial considerations pertaining to the campaign itself. The populated template may be issued to its intended recipient via any of several distribution means, which may vary depending on the embodiment. Such instances of populated templates may deliver either reflowable or non-reflowable content. In a non-limiting example, distribution means may include email, whereby the body of the email message sent to a given recipient customer contains the populated template itself. In another embodiment, the customized populated template may be included within said email message as an attachment in any format, including but not limited to a PDF file, or simply constitute a hyperlink to a designated web address where such content may be accessed and viewed using a web browser, as for example within a web site outfitted with e-commerce functionalities. In some embodiments, the customized template delivered to and accessed by the recipient customer may be partially or entirely laden with components of the tracking technology described previously herein, with the proper adaptations made for each deployment's distribution means.

Once the above-mentioned content, irrespective of distribution means, is made available to a customer, said customer may, in some embodiments, be provided with the ability to access further information on any one or all of the items appearing within the customized template via any of various selection means, including but not limited to pointing, clicking, and/or tapping on the area of the template occupied by a particular product listing. In many embodiments, details on the nature of every such attempt made by said customer to access further information about a product may be relayed back to the system's Client attributes (M13) module, using elements of the tracking technology discussed herein, in an attempt to continually update, improve, and perfect said customer's individual profile for future use, as for example in a later campaign. In an alternative embodiment, information so collected may also serve for analytics purposes beyond those pertaining directly to said customer; for example, interest data for multiple customers may be aggregated and used in an attempt both to qualitatively identify interest patterns and trends, as well as to variously assess said interest among one or more customers as well as among one or more product items presented to the latter. Indeed, in various embodiments and contexts, such assessments may be more concrete and thoroughly quantifiable based on existing analytics, in turn proving quite useful in market studies; in other scenarios where available analytics data is only partial or is altogether lacking, assessments provided may nonetheless prove useful for preliminary purposes, or in a hypothetical capacity concerned with providing an approximation beyond a mere guesstimate.

Finally, in some embodiments, the ability to select one or more items from within a populated template and be provided a means by which to purchase and/or procure additional information, as through a digital storefront, may also be envisioned.

Predictive Analytics

It will be appreciated that predictive analytics play a central role in the function and operation of various embodiments of the present invention. The purpose of predictive analysis may be appreciated here in terms of three interconnected marketing optimization objectives. The first of these objectives consists of increasing click-through rate by ensuring that pertinent solicitations are targeted as accurately as possible, meaning that they are issued to a known set of customers most interested in receiving them. Said interest is the product of careful client profile building efforts and is accordingly signaled through positive recipient customer reaction, such as clicking on a given solicitation that leads to additional summary information, such as viewing the trailer or preview of a video, reading the abstract of a publication, or the headline, byline and summary of a news article. The second objective aims to increase conversion rate, wherein said tentative preliminary interest transitions from a mere customer signaling of interest into a completed transaction, and may be seen as a commercial continuation of the first objective, said second objective typically but not exclusively being appreciated as the purchase of a solicited good or service. The third and final objective is in sorts a recursive optimization of its predecessors, but temporally spanning the course of each relationship formed between a set of solicited customers and an embodiment of the present invention.

The manner in which marketing effectiveness is increased using these three objectives is twofold. First among these is the construction of a holistic view of each individual among a given set of potential or target customers (M13), namely by amassing and storing attributes about said customers. The second objective consists of using the pairing module (M09A) to arrive at accurate predictions allowing whereby one or several articles to potentially solicit are matched with known client attributes (M13) in a manner that maximizes the likelihood that said solicitation will gain favorable or positive acceptance by targeted customer(s).

Accordingly, the practical delimitation of such “acceptance” may be appreciated as a relative and fluid notion, varying with such non-limiting factors as the context in which an embodiment is deployed; in addition, the nature of the article itself may play a role in interpreting a target recipient's acceptance of it. In the latter scenario, acceptance may range from a targeted recipient and potential customer clicking, tapping, or otherwise selecting a solicitation within a template, to reading or viewing content either in whole or in part, to placing an online order for a specified good, to purchasing a specified service, for example. Likewise, the related term “acceptance hit” may be useful to describe such phenomena, chiefly when contemplating positive recipient response from an internal perspective or with statistical analysis in mind. It will further be appreciated that the predictive aspects involved in the aforementioned pairing step (M09A) may vary. In particular, such predictive aspects may include but need not be limited to the simple solicitation of a particular transaction, nor to the completed issuance or successful delivery of a particular article to specific or otherwise targeted recipients customers based on a constructed detailed preferences profile of said clients.

Aspects involved in the predictive facet that embodiments of the present invention comprise may likewise vary. Given the rather wide field of potential application of the present invention, such aspects—some of which are non-exhaustively enumerated and described herein—should nonetheless be appreciated as cumulative and even potentially overlapping. It will be appreciated that the precise set, extent, and conceptual overlap of client attributes (M13) to collect, store, and analyze may vary in accordance with the overall marketing needs and/or specific performance objectives of the embodiment of the invention envisioned.

Likewise, the precise set of attributes to collect and upon which the predictive analytics assessments made by embodiments of the present invention are based may vary. In many embodiments, such analytics attributes, as well as the explanatory variables that they encapsulate, may be specified by a human operator having administrative and/or campaign management privileges. Additionally, the set, extent and scope of such attributes may be specified, without limitation, on a per-customer or even a per-campaign basis. The set of attributes actively involved in the predictive analytics operations carried out by embodiments of the present invention may be further selected from among a potentially larger set of explanatory variables that an embodiment of the present invention has been configured to track for each customer profile it constructs.

Embodiments of the present invention may further benefit from a modular design whereby predictive analytics components—whether the specific attributes to collect from customers' profiles or the means by which to algorithmically process them—are modifiable following the deployment and active use of said embodiments, with minimal or minor adverse impact on the successful operation of said embodiment. In a manner similar to modifications and/or upgrades to any module described herein, such modifications may be variously applied, as appropriate, using various strategies, including on-site, in-situ, remotely, or by qualified administration personnel, all consistent with optimization goals described herein and the requirements specific to the needs of the embodiment of the invention. Such modifications may vary in scope and be self-contained, as in a self-executing software upgrade package, or alternatively require comprehensive structural changes to an embodiment of the present invention. Likewise, said modifications may be deployed routinely, periodically, or whenever deemed appropriate or necessary by campaign management personnel, and be based on innovative analytics strategies, or to optimize existing ones. Direction on whether and when to implement any such modification may be considered when it becomes apparent that such components, either specifically or broadly, require said modification to further the objectives of the embodiment of the present invention. Typically, such decisions are jointly arrived at following careful review of under-optimized facets of said embodiment(s) and a collaborative consultation on tangible remedies to apply to said under-optimizations by administrative marketing campaign personnel and one or more persons skilled in the art and possessing the ability to develop said modifications.

Possible Input Values

A non-limiting discussion of the sort of information collected and which partially populates the client attribute data (M13) set follows presently. Each of the input values that follow and which are enumerated without limitation herein, may contribute to predictive analytics processes used by various embodiments of the present invention to optimize the targeting and matching of specific recipients with articles solicited.

While the location of a given target customer may be statically disclosed—on a profile creation form, for example—whenever said customer becomes affiliated with an embodiment of the present invention, it may be desirable to exploit more granular information on the geographic location of said customer for the purposes of predictive analytics operations. For example, GPS coordinates, timestamps, and basic information about the device and platform on which a solicitation is received may be requested by an embodiment of the invention, which may track and combine said data and target client viewing habits. This information may be utilized to draw inferences about the likelihood of success with future solicitations of same or similar nature based on a potential customer's whereabouts. Inversely, the predictive analytics may also be exploited to discern possible patterns in the types of articles whose solicitation is successful based upon location, device, and timestamp data.

A second possible input value type which may prove statistically valuable is the number of articles presented to a given customer in the course of a particular marketing campaign or even within a given solicitation message or template. Such information may be combined with other data described herein to evaluate and potentially optimize subsequent marketing initiatives. Such optimizations may focus on tailoring the nature, length, and presentation of future correspondence to be assembled and transmitted to a target customer.

A third possible input value type might be one that includes metrics intended to quantify the relative breadth of traffic handled by an embodiment of the invention. These include, without limitation, the number of active customers to whom solicitations may be sent, the number of solicitations sent to each customer (or alternatively to a group of clients) in the course of a specific campaign, or the total number of articles from one or several sources (e.g. retailers, distribution companies, publishers) available or displayed to all such customers.

A fourth possible input value type might focus on specific aspects of click-through or conversion rates achieved using a given embodiment of the present invention. For example, statistics such as those tallying the number of clicks (or some other form of acceptance hit as discussed herein) made by targeted customers further to a given solicitation may prove useful to this end. A related value might likewise tally total number of acceptance hits from all links displayed on all web sites during a specified time interval. Similarly, yet another value would be a running count of the number of successful transactions (e.g. a solicited good or service being purchased by a targeted customer) logged by an embodiment of the invention over a given time interval.

A fifth possible input value type follows the theme of the preceding type, but from the perspective of each individual customer profile, as opposed to a cumulative total collected from all sources taken together. Thus, in the present grouping, such metrics as the total number of acceptance hits made by each specific customer profile during a given campaign might be counted. Relatedly, the total number of acceptance hits logged by a specific customer profile holder on a specific merchant, for example, might be tallied. Finally, a running count of the total number of transactions made by each specific account holder could also be collected.

Additionally, the attributes and data collected and stored in one or more explanatory variables may, in certain embodiments, be aggregated or otherwise combined, without limitation. For example, data stored in multiple different explanatory variables within the client attributes profile of a specific customer may be combined in order to draw one or more predictive inferences about said customer. Conversely, data collected and stored for the same explanatory variable and belonging to a set of customers may likewise be combined in order to draw one or more predictive inferences about a given group. Finally, it will be appreciated that in order for an embodiment of the invention to construct a holistic view of a target customer set and draw more sophisticated predictive inferences further to conducting better optimized and targeted campaigns, more complex combinations of explanatory variables, simultaneously aggregating the foregoing multiple-variable/single-customer and single-variable/multiple-customer client attribute combination strategies.

Input value types such as those described above and the resulting predictive analytics may be exploited to produce outcomes in various commercial scenarios while fulfilling the principal objective of embodiments of the present invention to increase marketing effectiveness. For example, a pizza chain with a local franchise might engage an embodiment of the present invention or retain the services of a firm using the same to solicit a given customer known by said embodiment to consume pizza on given days of the week and especially at certain times of the day.

Likewise, a casino that provides players with a personal authentication mechanism (such as a magnetic stripe or chip-enabled ID card with centralized integrated payment functionalities) to facilitate game play might similarly benefit from such analysis. Said casino might for example identify behavioral patterns of a given player and direct its employees to take specific action to variously trigger a particular behavior (such as playing a particular game or purchasing a drink or meal) or alternatively to forestall scenarios or prevent certain outcomes altogether (such as by engaging a player whose betting profile suggests a lower-income individual with a potential gambling problem to consider interrupting gameplay or even consider a self-ban).

In another scenario, the relative placement of articles or descriptions within a solicitation may be combined with predictive analytics further to a specific marketing objective. For example, the placement of article descriptions within a populated solicitation template customized for a specific customer may be specified to adhere to specific criteria. For example, said articles may be arranged to appear in such manner as to encourage a target recipient to first browse through slightly less articles (though nonetheless known to be desirable to said recipient). Alternatively, placement of articles may follow some other criterion, such as placing those with greater or lesser profit margins in key places, or articles with greater popularity at “prime” spots within a template.

Furthermore, each of the foregoing data values non-exhaustively enumerated may be combined in data mining and analytics exercises for purposes of extracting robust results with ease and doing so in a manner that is easily adaptable. Thus, it will further be appreciated that the precise combinations of explanatory variables, as well as their exploitable inferential value, varies according to the needs of specific embodiments of the present invention.

Post-click Analysis

An important element in collecting the predictive analytics described herein involves the iterative process by which post-click tracking data is communicated back to the various modules of the present invention following receipt by a customer of a populated template.

As described herein, acceptance denotes a general signaling by a customer of some interest in one or more items within a populated template he or she receives. Various scenarios may be imagined wherein a customer will generate an acceptance hit for one or at most a few items within a populated template; likewise, in other cases, a customer might signal some cursory interest by viewing all items in said populated template. In an embodiment of the invention, a portion of the predictive analytics collection process may be configured to interpret not only the post-click data collected regarding a customer's relative interest of any and all content solicited, but also have the ability to interpret the relative interest level in products by measuring, for example, the amount of time spent in connection with one item within the populated template as compared to another item. In at least one embodiment of the invention, such appeal might accordingly be measured by way of one or more input values specified and configured to quantify customer interest as a function of how much time a customer might spend investigating each solicited item appearing within a populated template.

A customer's signaling acceptance of an article appearing within a populated template operates a feedback mechanism that involves two principal modules described herein, namely the Text Analysis (M03) and Client Attributes (M13) modules. This is because acceptance is understood, on the one hand, as an at least partial endorsement by the customer of the set of keywords generated by the Text Analysis module (M03) for a particular article. On the other hand, the customer's interest in said article may also be understood within one or more predictive analytics input values unconnected to keywords or article attributes alone. Instead, interest in a particular article may be understood as the natural extension of a behavioral trait that may become increasingly apparent following iterative campaigns and associated post-click predictive analytics collection.

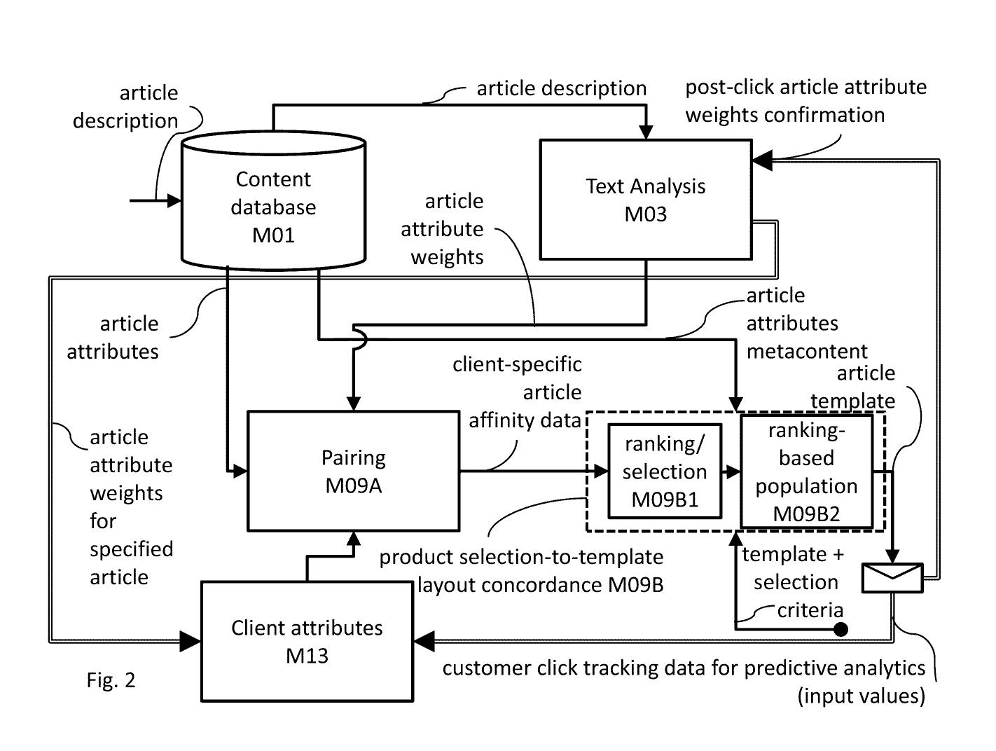

Building upon an example developed earlier, a customer might be known to prefer a particular model of mobile phone. However, the collection of predictive analytics for said customer might also enable an embodiment of the invention to have an input value type configured to ascertain customer color preferences for articles solicited. Accordingly, in such a scenario, the embodiment of the invention does not know that said customer prefers blue-colored items as opposed to red-colored ones, which is nonetheless the case. Further, in this example scenario, the populated template viewed by said customer includes entries for two variants of said mobile phone models which differ only in color, where one variant solicited is blue and the other red. In this scenario, an acceptance hit for the blue model device might result, while the red model will be completely ignored by the customer. In this case, a quantitative increase in said customer's scores for the subset of attributes' weights corresponding to the mobile phone will be increased, in addition to said customer's scores corresponding to the input value for the color blue. In an embodiment (FIG. 2), upon such an acceptance hit generated by the customer, the Text Analysis (M03) module may be solicited to identify the article attribute weights for the mobile phone having generated said acceptance hit, and provide these to the Client attributes (M13) module. Further, the client attributes module receives click-tracking data in the form of an input value configured to identify color preferences and incrementally increases the input value identifying preference for the color blue

Finally, it will be appreciated that the implementation of the click-tracking and predictive analytics collection process described herein should be appreciated broadly and non-limitingly and thus not be restricted or constrained to the single embodiments and examples developed for illustrative purposes alone.

What is claimed is:

1. An article classification and selection system comprising:
a content database containing a set of texts for a set of articles;
a text analysis module configured to accept said article descriptions and generate weighted article attribute values extracted from said article descriptions;
a pairing module configured to match said article attributes and said weighted article attribute values with client attributes to produce a weighted set of client-specific article affinity data.

2. The system defined in claim 1, further comprising an article selection-to-template layout concordance module configured to accept said weighted client-specific article affinity data from said pairing module, of which at least a portion originates from said article descriptions retrieved from said content database, and contains one or more said article attributes, or one or more said article attribute weights, and externally-supplied template and matching criteria to populate said template with a content and layout personalized for a customer having said client attributes.

3. The system defined in claim 1 or 2, wherein said article selection-to-template layout concordance module is configured to populate a content template in which is presented a subset of articles originating from said content database.

4. The system defined in claim 1, 2, or 3, further configured to externally override one or more template population selections made by the article selection-to-template layout concordance module.

5. The system defined in any of claims 1 through 4, wherein the Text Analysis module is configured to interpret, infer, and generate meaningful thematic category groupings from said article descriptions and provide said groupings to the Pairing module.

6. The system defined in claim 5, wherein the result of said inference and generation is one or more category groupings, where a part or all of the latter's literal content may be expressed using synonymous expressions, translations, equivalent, or external formulations of various abstractions, to information featured within said article description itself.

7. The system defined in claim 6, wherein said thematic category groupings are expressed as alphanumeric strings.

8. The system defined in any of claims 1 through 7, wherein the Text Analysis module is implemented using a neural network.

9. The system defined in any of claims 1 through 8, wherein the content template is an advertisement template.

10. The system defined in any of claims 1 through 9, wherein said content and said layout personalized for said customer are used for purposes of mass solicitation involving e-mail or other internet marketing mechanisms.
